(19) United States
(12) Patent Application Publication
(10) Pub. No.: US 2025/0013200 A1
(43) Pub. Date: Jan. 9, 2025

(54) DEVICE, WATCH, AND METHOD FOR MANUFACTURING THE DEVICE

(71) Applicant: CASIO COMPUTER CO., LTD., Tokyo (JP)

(72) Inventors: Yukio FUNABARA, Tokyo (JP); Koichiro MATSUSHITA, Tokyo (JP)

(73) Assignee: CASIO COMPUTER CO., LTD., Tokyo (JP)

(21) Appl. No.: 18/755,695

(22) Filed: Jun. 27, 2024

(30) Foreign Application Priority Data
Jul. 6, 2023 (CN) 202310827564.1

(51) Int. Cl. G04B 37/00; G04B 37/22

(52) U.S. Cl. CPC G04B 37/005; G04B 37/22

(57) ABSTRACT

A device includes: a case having an accommodation portion; and a cover arranged in the accommodation portion of the case, in which a first recessed portion is formed in any one of a bottom surface portion in the accommodation portion of the case and a surface of the cover facing the bottom surface portion, and in which a second recessed portion is formed in an outer peripheral surface of the cover. The device has an adhesive escape structure.

### CROSS-REFERENCE TO RELATED APPLICATIONS

This application claims priority to and benefit of Chinese Patent application No. 202310827564.1 filed on Jul. 6, 2023. The entire specification, claims, and drawings of Chinese Patent application No. 202310827564.1 are incorporated herein by reference.

### TECHNICAL FIELD

The present disclosure relates to a device, a watch, and a method for manufacturing the device.

### BACKGROUND

Regarding a structure in which a cover is adhesively fixed to a case by an adhesive in a device such as a watch, it is known that an excess adhesive is absorbed in a groove provided on an inner surface of the case, whereby the adhesive is prevented from protruding to an exterior surface (for example, JP56-27686U1).

### SUMMARY

A device according to an illustrative embodiment of the present disclosure includes: a case having an accommodation portion; and a cover arranged in the accommodation portion of the case, in which a first recessed portion is formed in any one of a bottom surface portion in the accommodation portion of the case and a surface of the cover facing the bottom surface portion, and in which a second recessed portion is formed in an outer peripheral surface of the cover. The device has an adhesive escape structure.

According to the present disclosure, it is possible to suppress protrusion of an adhesive.

### BRIEF DESCRIPTION OF DRAWINGS

FIG. 1 is a plan view of a watch according to a first illustrative embodiment of the present disclosure.

FIG. 2 is a cross-sectional view showing a part of the watch.

FIG. 3 is a cross-sectional view showing a part of a watch according to a second illustrative embodiment of the present disclosure.

FIG. 4 is a cross-sectional view showing a part of a watch according to another illustrative embodiment 1 of the present disclosure.

FIG. 5 is a cross-sectional view showing a part of a watch according to another illustrative embodiment 2 of the present disclosure.

FIG. 6 is a cross-sectional view showing a part of a watch according to another illustrative embodiment 3 of the present disclosure.

### DETAILED DESCRIPTION

In the above-described related art, however, the method of providing the groove for escaping the adhesive on the inner peripheral surface of the case requires cutting the case side, which increases the cost.

Therefore, illustrative aspects of the present disclosure provide a device, a watch, and a method for manufacturing the device, which can suppress protrusion of an adhesive.

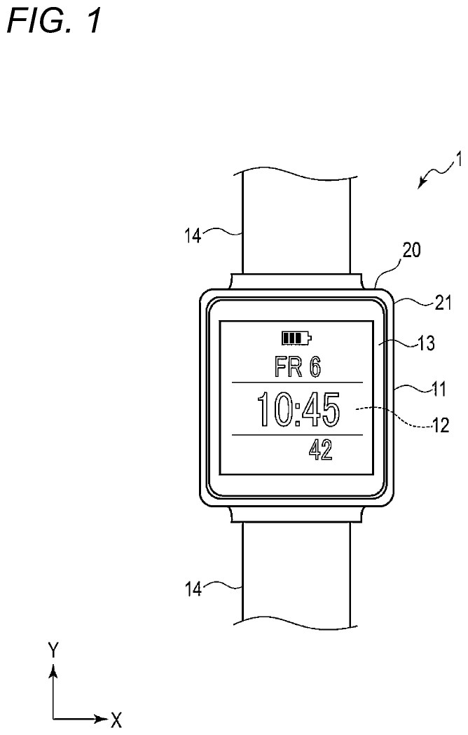

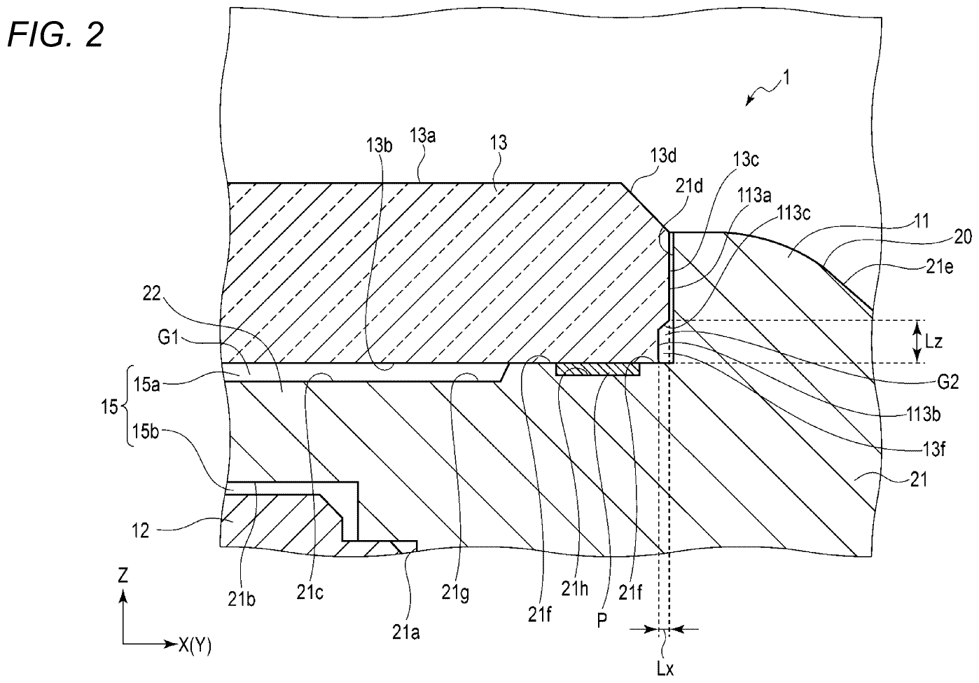

Hereinafter, a watch 1 according to a first illustrative embodiment of the present disclosure will be described with reference to FIGS. 1 and 2. FIG. 1 is a plan view of a watch 1 according to a first illustrative embodiment, and FIG. 2 is a cross-sectional view showing a part of the watch 1. In the present illustrative embodiment, an example in which a device is applied to a dial of the watch 1 is shown. X, Y, and Z in the drawings represent three directions orthogonal to each other, respectively. For example, in the present illustrative embodiment, the watch 1 is described using, as an example, a posture in which a first direction along the Z axis is a front and back direction of the watch 1, the Y axis is a longitudinal direction connecting 6 o'clock and 12 o'clock, and the X axis is a lateral direction connecting 3 o'clock and 9 o'clock, but is not limited thereto.

The watch 1 as a device shown in FIGS. 1 and 2 is, for example, a wristwatch, and includes a watch case 11 configuring an outer frame, a watch module 12 provided within the watch case 11, a transparent cover 13 covering a front side that is one side in the first direction of the watch module 12, and a back cover (not shown) covering a back side that is the other side in the first direction of the watch module 12. In addition, the watch 1 includes watch bands 14 connected to two locations on an outer peripheral portion of the watch case 11, and a plurality of switches arranged on the outer periphery of the watch case 11.

The watch case 11 includes a frame body 20 arranged on an outer peripheral portion of the watch module 12. The watch case 11 is provided with band attachment portions to which the watch bands 14 are attached at two facing locations on the outer peripheral portion, for example, at the 6 o'clock and 12 o'clock positions of the watch, respectively.

The frame body 20 is made of a metal or resin material, has a peripheral wall portion 21 covering the outer peripheral portions of the watch module 12 and the cover 13, and is formed at a central portion with an accommodation portion 15 that serves as a space where the watch module 12 and the cover 13 are arranged. In the present illustrative embodiment, the frame body 20 and the accommodation portion 15 are each formed in a rectangular shape. That is, the frame body 20 is formed in a quadrangular shape surrounded by two sides extending in the lateral direction along the X-axis and two sides extending in the longitudinal direction along the Y-axis. For example, in the present illustrative embodiment, an inner and outer direction of the watch case 11 is a direction orthogonal to the peripheral direction and the front and back direction. For example, for the sides along the longitudinal direction, the lateral direction is the inner and outer direction, and for the sides along the lateral direction, the longitudinal direction is the inner and outer direction. Note that when the watch case 11 has a circular shape, the shapes of the frame body 20 and the accommodation portion 15 are also formed in a circular shape.

The peripheral wall portion 21 has a protruding wall portion 22 protruding in an inner periphery direction over an entire periphery. Note that the frame body 20 may be configured by combining a plurality of case members.

The accommodation portion 15 is a recessed portion where the watch module 12 and the cover 13 are arranged. The accommodation portion 15 is a space opening on the front side and the back side. For example, in the frame body 20, the front side of the opening configuring the accommodation portion 15 is covered by the cover 13, and the back side is covered by the back cover.

As an example, the accommodation portion 15 of the watch case 11 has a first accommodation portion 15a where the cover 13 is arranged and a second accommodation portion 15b where the watch module 12 is arranged behind the first accommodation portion 15a. The protruding wall portion 22 where a part of an inner peripheral surface of the frame body 20 protrudes inward is arranged between the first accommodation portion 15a and the second accommodation portion 15b.

On the inner peripheral surface of the frame body 20, a plurality of steps are formed corresponding to arrangement of components. For example, a surface of the frame body 20 includes a first inner peripheral surface 21a facing the outer periphery of the watch module 12, a back edge surface 21b that is a back surface of the protruding wall portion 22 and is arranged on a front side of an outer peripheral edge portion of the watch module 12, a front edge surface 21c that is a front surface of the protruding wall portion 22 and faces a back side of a peripheral edge of the cover 13, a second inner peripheral surface 21d facing the outer peripheral surface of the cover 13, an outer front surface 21e, and a back surface part.

That is, in the watch case 11, a watch module support part is formed by the first inner peripheral surface 21a forming the second accommodation portion 15b and the back edge surface 21b that is the back surface of the protruding wall portion 22, and a cover support part is formed by the front edge surface 21c that is the front surface of the protruding wall portion 22 and the second inner peripheral surface 21d configuring the first accommodation portion 15a.

The first inner peripheral surface 21a is an inner wall surface erected along the first direction and is arranged facing an outer side of the outer peripheral portion of the watch module 12.

The back edge surface 21b is a back surface of the protruding wall portion continuous and extending radially inward from a front-side end portion of the first inner peripheral surface 21a, and forms a plane orthogonal to the first direction, which is a thickness direction of the watch 1. The back edge surface 21b is arranged facing a front surface of the peripheral edge of the watch module 12. For example, the back edge surface 21b of the protruding wall portion 22 becomes a pressing portion that regulates a position of the watch module 12 in the first direction. The back edge surface 21b of the protruding wall portion 22 may have a step or unevenness corresponding to a facing member.

The front edge surface 21c is arranged facing a peripheral edge of the back surface of the cover 13. An end edge on an outer periphery side of the front edge surface 21c is arranged outside an end edge on an outer periphery side of the back edge surface 21b.

The front edge surface 21c includes a bottom support portion 21f supporting a back surface side of the peripheral edge portion of the cover 13, a retraction recessed portion 21g retracted backward on an inner side of the bottom support portion 21f, and a holding groove portion 21h (first recessed portion) retracted backward on an outer side of the bottom support portion 21f, an adhesive being arranged in the holding groove portion.

The bottom support portion 21f has a bottom surface portion facing the back surface of the cover 13 in a region on the outer periphery side of the front surface of the protruding wall portion 22. The bottom support portion 21f has an upper surface (a surface on one side) located closer to a front side than a bottom surface of the retraction recessed portion 21g and having a flat surface portion orthogonal to the first direction, and is in contact with or arranged facing the back surface of the cover 13 to support the cover 13. For example, the bottom support portion 21f extends from a base end portion on the back side of the second inner peripheral surface 21d toward the inner periphery side, and has a flat surface divided into two parts by the holding groove portion 21h. That is, by forming the holding groove portion 21h in the bottom support portion 21f, regions on inner and outer sides of the holding groove portion 21h are respectively arranged facing the back surface side of the outer peripheral portion of the cover 13 at positions closer to the front side than the bottom surface of the holding groove portion 21h.

The retraction recessed portion 21g is formed in a region on the center side of the watch case 11 on the front surface of the protruding wall portion 22, and forms a bottom surface more retracted backward than the bottom support portion 21f. The bottom surface of the retraction recessed portion 21g is arranged with a predetermined gap G1 with respect to the back surface of the cover 13. That is, between the front surface of the protruding wall portion 22 of the watch case 11 and the back surface of the cover 13, the region on the center side is arranged to be spaced apart in the front and back direction, and the gap G1 whose entire periphery is surrounded by the bottom support portion 21f is formed.

The holding groove portion 21h is a peripheral groove in which a region on the outer periphery side of the bottom support portion 21f is recessed backward, and is formed continuously over the entire periphery in the peripheral direction of the frame-shaped watch case 11. The holding groove portion 21h holds an adhesive P and configures an adhesive portion for adhering the watch case 11 and the cover 13. Here, a dimension of the holding groove portion 21h in the first direction that is a depth direction (along the Z axis) is configured to be shallower than a dimension in the depth direction of the retraction recessed portion 21g formed adjacent thereto. In addition, the holding groove portion 21h is configured such that a dimension in a groove width direction along the inner and outer direction is larger than a dimension in the depth direction along the first direction (along the Z-axis).

Noe that a depth of the holding groove portion 21h may be deeper than a depth of the retraction recessed portion 21g. Additionally, the depth of the holding groove portion 21h may be larger than the groove width of the holding groove portion 21h.

The second inner peripheral surface 21d is an inner wall surface erected on the front side along the first direction from the end edge on the outer periphery side of the front surface of the protruding wall portion 22, and is arranged facing the outer side of the outer peripheral portion of the cover 13. For example, the second inner peripheral surface 21d is located outside the first inner peripheral surface 21a.

The outer front surface 21e extends outward from the front-side end portion of the second inner peripheral surface 21d and configures front-side and outer periphery-side surfaces of the watch case 11.

The back surface portion of the frame body 20 is joined to the back cover by adhesion or fastening. For example, a waterproof ring is mounted on the back surface portion of the frame body 20 to seal a gap with the back cover.

The watch module 12 is accommodated in the accommodation portion 15 of the frame body 20. For example, the watch module 12 is arranged on the back side of the cover 13 and in the first accommodation portion 15a, which is a region on the back side of the accommodation portion 15. For example, the watch module 12 includes a display device that displays various information such as a time, and a circuit board on which various electronic components such as an IC as a driving unit and an antenna are mounted. In addition to this, the watch module 12 includes a battery, a solar board, various sensor components, and various other components necessary for watch functions. In the present illustrative embodiment, the display device and the circuit board stacked and arranged are formed, for example, in a rectangular shape corresponding to the shape of the watch case 11.

The cover 13 is a transparent member made of a light-transmitting material such as SiO₂ glass, for example. For example, the cover 13 is a watch glass having a rectangular plate shape following the shape of the first accommodation portion 15, is arranged on the front side of the watch module 12, and covers the front side of the watch module 12. For example, the cover 13 is supported on the inner peripheral edge of the opening on the front side of the watch case 11. The cover 13 has a peripheral surface portion on the back side arranged facing the bottom support portion 21f having the holding groove portion 21h and is bonded to the watch case 11 by the adhesive P supplied to the holding groove portion 21h. As an example, in the present illustrative embodiment, the cover 13 is bonded to the frame body 20 of the watch case 11 with a packing interposed between the cover and the frame body 20 of the watch case 11 and by the adhesive P.

The cover 13 is configured in a plate shape and has a front surface 13a, a back surface 13b, and an outer peripheral surface 13c. The front surface 13a and the back surface 13b configure a flat surface orthogonal to an axial direction. Additionally, an edge portion between the front surface 13a and the outer peripheral surface 13c configures an inclined surface 13d cut by chamfering.

The edge portion between the back surface 13b and the outer peripheral surface 13c of the cover 13, that is, a corner portion that is an end portion on the back side of the outer peripheral surface 13c is formed with an escape groove portion 13f (second recessed portion) that is a notch formed along the peripheral direction over the entire periphery. That is, a partial region on the back side of the outer peripheral surface 13c of the cover 13 is more retracted toward the inner side of the watch case 11 than a region on the front side.

For example, the outer peripheral surface 13c of the cover 13 includes a first peripheral surface portion 113a on the front side, a second peripheral surface portion 113b more retracted inward than the first peripheral surface portion 113a, and a ceiling portion 113c connecting the first peripheral surface portion 113a and the second peripheral surface portion 113b. That is, the escape groove portion 13f is formed by the second peripheral surface portion 113b, which is a longitudinal surface portion facing the inner surface of the peripheral wall portion of the accommodation portion 15 with a gap interposed therebetween, and the ceiling portion 113c inclined with respect to and facing the bottom surface portion of the case 11.

The first peripheral surface portion 113a is arranged facing the second inner peripheral surface 21d of the frame body 20.

The second peripheral surface portion 113b (longitudinal surface portion) is spaced apart from and faces the second inner peripheral surface 21d with a predetermined gap G2 interposed therebetween. That is, the second peripheral surface portion 113b is arranged at a position more retracted inward than the first peripheral surface portion 113a.

The ceiling portion 113c continues the first peripheral surface portion 113a and the second peripheral surface portion 113b. The ceiling portion is inclined with respect to the front and back direction and the inner and outer direction. For example, the ceiling portion has a tapered inclined surface extending outward and toward the front side from the second peripheral surface portion 113b.

For example, the cover 13 is configured such that an area of a cross section orthogonal to the first direction cut at the second peripheral surface portion 113b is smaller than an area of a cross section orthogonal to the first direction cut at the first peripheral surface portion 113a.

The first peripheral surface portion 113a and the second peripheral surface portion 113b have surfaces parallel to each other. For example, the peripheral surface portions 113a and 113b each have two sets of lateral and longitudinal flat surface portions.

In a cross-sectional view, the escape groove portion 13f is configured in a trapezoidal shape with an inclined side on the front side. The escape groove portion 13f is spaced apart from the holding groove portion 21h in which the adhesive is arranged, with a part of the bottom support portion 21f interposed therebetween. That is, the escape groove portion 13f is arranged at a distance from the holding groove portion 21h on the outer periphery side of the watch case 11. The escape groove portion 13f is configured such that a dimension Lz in the first direction along the front and back direction is larger than a dimension Lx in the inner and outer direction orthogonal to the first direction and the peripheral direction. That is, the escape groove portion 13f is configured such that a dimension in the groove width direction along the first direction is larger than a dimension in the depth direction of the groove along the inner and outer direction. The escape groove portion 13f becomes an escape portion (adhesive escape structure portion) into which the excess of the adhesive P arranged in the holding groove portion 21h is introduced.

At least one of the holding groove portion 21h, which is the first recessed portion, or the escape groove portion 13f, which is the second recessed portion, holds the adhesive. In addition, at least one of the holding groove portion 21h or the escape groove portion 13f configures an adhesive escape structure in which the adhesive is accommodated when the adhesive protrudes. That is, the watch 1 as a device has an adhesive escape structure.

For example, when the excess of the adhesive P arranged in the holding groove portion 21h enters the escape groove portion 13f, the escape groove portion 13f becomes an adhesive escape structure. Alternatively, when the excess of the adhesive P arranged in the escape groove portion 13f enters the holding groove portion 21h, the holding groove portion 21h becomes an adhesive escape structure.

For example, when the cover 13 is formed by molding of resin glass, the escape groove portion 13f can be formed without increasing the number of processes by forming a projection on a mold that is used when pouring the resin into the mold. Additionally, when the cover 13 is made of inorganic glass, the escape groove portion 13f can be formed simultaneously with side polishing by providing a projection or step on a polishing tool.

The watch bands 14 include a connecting mechanism, such as a pair of band members and a buckle, respectively connected to two facing locations on the outer periphery of the watch case 11.

The switch is provided, for example, on the outer peripheral portion of the case, and switches a mode of the watch module 12 or adjusts a time by an operator pressing the switch.

The watch case 11 and the cover 13 configured as above are adhesively fixed to the cover 13 by the adhesive P arranged in the holding groove portion 21h.

For example, in an assembly process of the watch 1, the adhesive P is applied into the holding groove portion 21h formed on the outer periphery side of the bottom surface of the accommodation portion 15 of the watch case 11, and the cover 13 is inserted from the front side of the frame body 20 of the watch case 11 and adhesively fixed.

For the adhesive P, for example, a silicone-based or urethane-based resin that has elasticity and hardens with temperature and humidity is used.

That is, a method for manufacturing the watch 1 according to the present illustrative embodiment includes a first process of applying an adhesive into the holding groove portion 21h as the first recessed portion formed in at least one of the bottom surface portion within the accommodation portion 15 of the case 11 or a lower surface of the cover 13, and a second process of inserting and adhesively fixing the cover 13 into the accommodation portion 15 of the case 11 after the first process. In the second process, the adhesive protruding from the holding groove portion 21h enters the escape groove portion 13f, which is a second recessed portion formed in the outer peripheral surface of the cover 13.

According to the device and the watch 1 according to the present illustrative embodiment, even if the adhesive P supplied to the holding groove portion 21h protrudes to the outer periphery side surface side during the assembly process of the watch 1, the adhesive P enters the escape groove portion 13f formed in the outer peripheral surface of the cover 13. As a result, the adhesive P can be prevented from protruding to the outer front surface of the case.

In addition, the escape groove portion 13f has a structure having a peripheral surface erected toward the front side, and the dimension in the inner and outer direction can be made smaller by making the dimension in the front and back direction longer compared to, for example, a chamfered shape. That is, a volume of the escape groove can be secured without deteriorating the appearance. For example, when forming a C chamfer on a corner portion of the back surface of the cover 13, it is necessary to enlarge the C chamber inward so as to secure a volume, which affects the appearance. However, in the present illustrative embodiment described above, the dimension of the escape groove is secured in the first direction along the front and back direction, so the escape groove has a shape that is not noticeable when viewed from the front side.

As in the related art, when forming a groove in the inner peripheral surface of the case side, it is necessary to add a cutting process using a cutting tool. However, for example, when resin glass is used as the cover 13, resin is poured into a mold and molded. Therefore, the cover can be formed without increasing the number of processes by forming a projection on the mold. In addition, when inorganic glass is used as the cover 13, a notch shape can be formed during side polishing, which is usually performed, and therefore the first recessed portion can be formed at the same time. Therefore, the escape portion for the adhesive can be easily formed without increasing the number of processes.

Note that the escape groove portion 13f is not continuous with the holding groove portion 21h and is configured to be spaced apart from the bottom support portion 21f with a part of the bottom support portion interposed therebetween. Thereby, the volume of the holding groove portion 21h can be suppressed and the required amount of adhesive can be suppressed, making it possible to absorb the excess of the adhesive while securing adhesiveness. That is, the adhesive can be preferentially spread in the holding groove portion 21h, and then the excess of the adhesive P can be absorbed into the escape groove portion 13f.

In addition, since the cross-sectional area of the corner portion on the back surface side of the outer peripheral surface of the cover 13 according to the above illustrative embodiment is reduced by notching, the cover can be a lead-in during assembly when inserting and mounting the cover 13 into the accommodation portion 15 of the watch case 11 and can guide the incorporating operation, leading to improvement in ease of assembly.

In addition, since the first peripheral surface portion 113a and the second peripheral surface portion 113b are made continuous by the ceiling portion 113c enlarged in a tapered shape, they can guide the insertion into the accommodation portion 15, leading to further improvement in ease of assembly. If the lower surface (surface on the other side) of the cover 13 is simply C-chamfered to be the same as the upper surface (surface on one side), the C-chamfer (adhesive) will become noticeable as it becomes large inward. In the first illustrative embodiment, the capacity of the adhesive pool increases in the height direction of the notch, so it is not noticeable when viewed from the upper surface.

Note that the above-described illustrative embodiment is an example and does not limit the scope of the invention. Additionally, features of multiple illustrative embodiments may be combined.

### Second Illustrative Embodiment

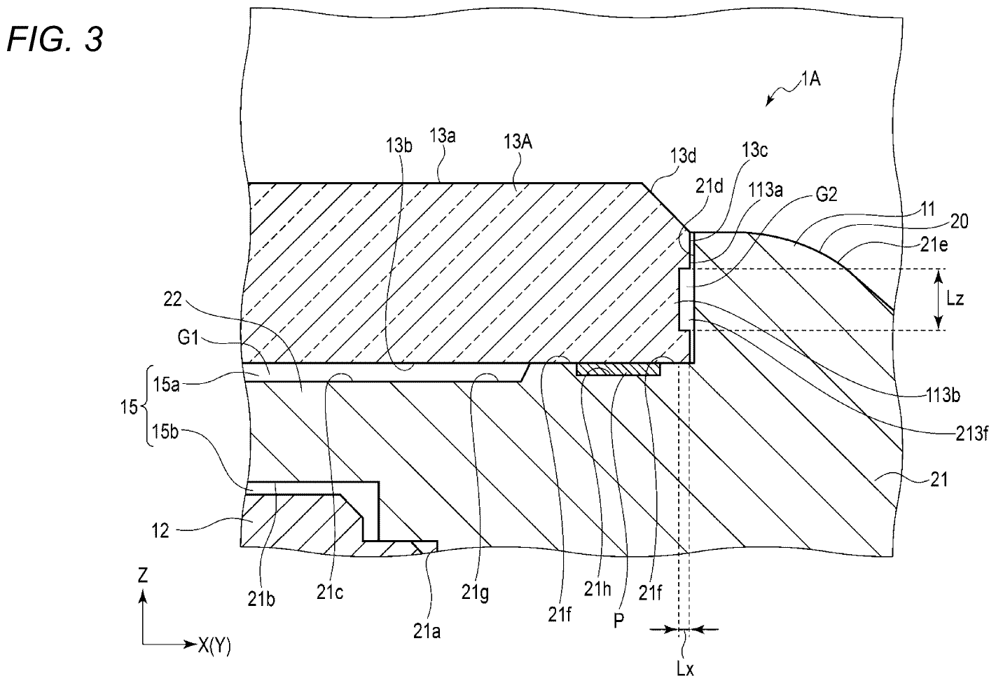

In the first illustrative embodiment, the example has been described in which the holding groove portion 21h in which adhesive P is arranged is formed in the corner portion of the back side of the cover 13, but the present invention is not limited thereto. For example, as in a cover 13A of a watch 1A shown in FIG. 3 as a second illustrative embodiment, an escape groove portion 213f may be formed around the entire periphery near the center in the axial direction of the outer peripheral surface 13c.

When resin glass is used as the cover 13, in the cutting process, a groove can be formed without increasing the number of processes by matching a cutting tool shape to a product side surface shape. Additionally, when inorganic glass is used as the cover 13, a groove can be formed simultaneously with the side polishing, so the number of man-hours is not increased. This is possible by providing an annular protruding portion on a part of the whetstone.

### Another Illustrative Embodiment 1

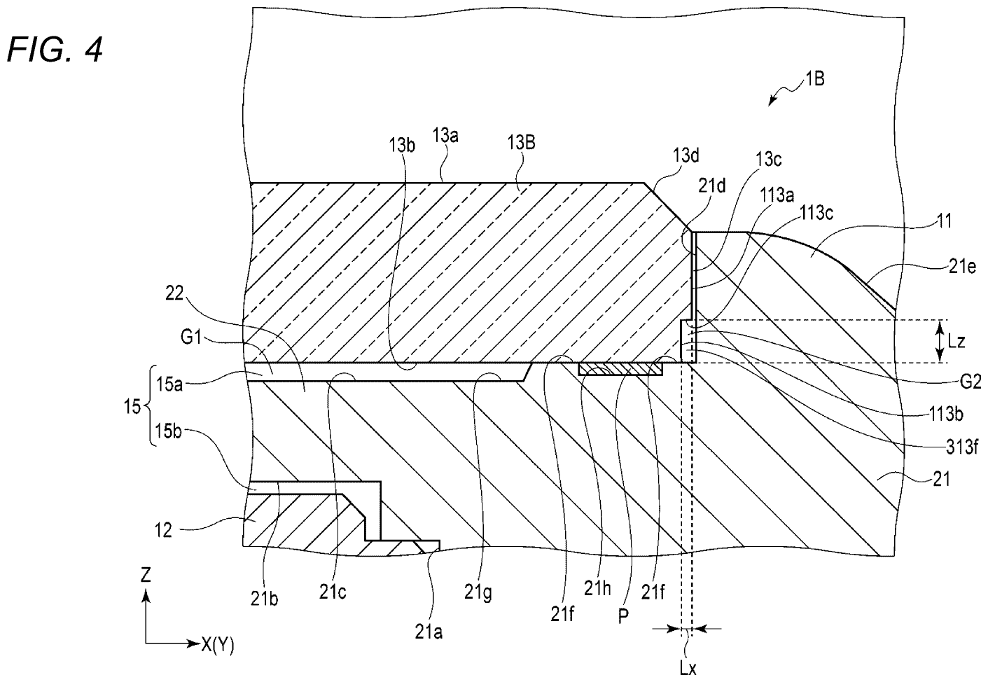

In the first illustrative embodiment, the example has been described in which the escape groove portion 13f is formed in a trapezoidal shape in which the ceiling portion 113c has a tapered inclined surface, but the present invention is not limited thereto. As in a cover 13B of a watch 1B shown in FIG. 4 as another illustrative embodiment 1, an escape groove portion 313f having a rectangular cross-sectional shape may be provided.

### Another Illustrative Embodiment 2

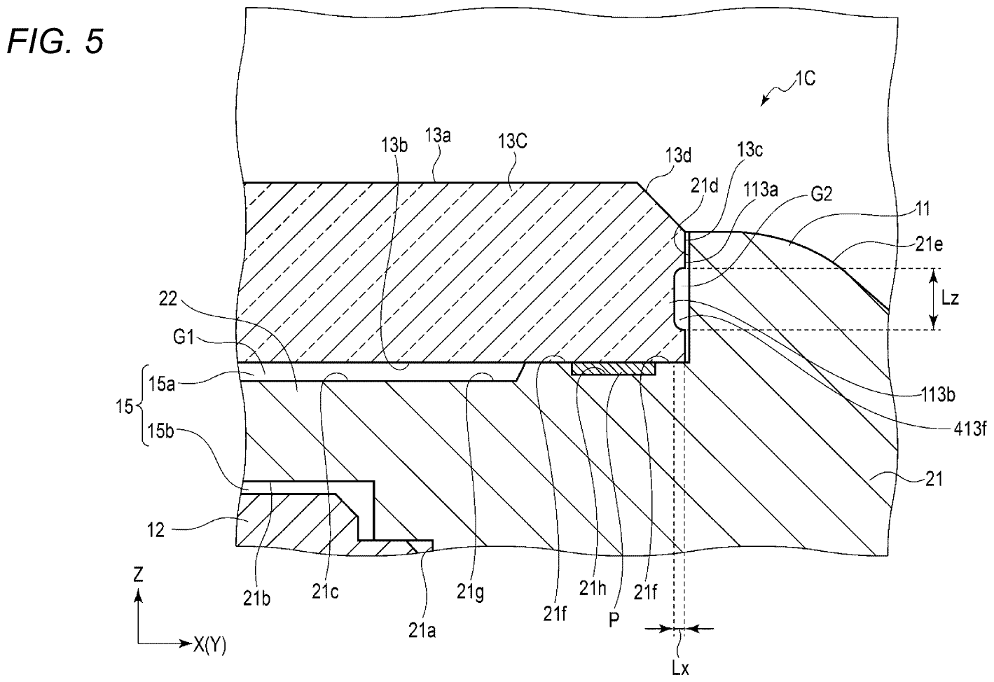

In addition, as in a cover 13C of a watch 1C shown in FIG. 5 as another illustrative embodiment 2, an escape groove portion 413f in which an inner surface of a groove is formed in a curved shape may be provided.

### Another Illustrative Embodiment 3

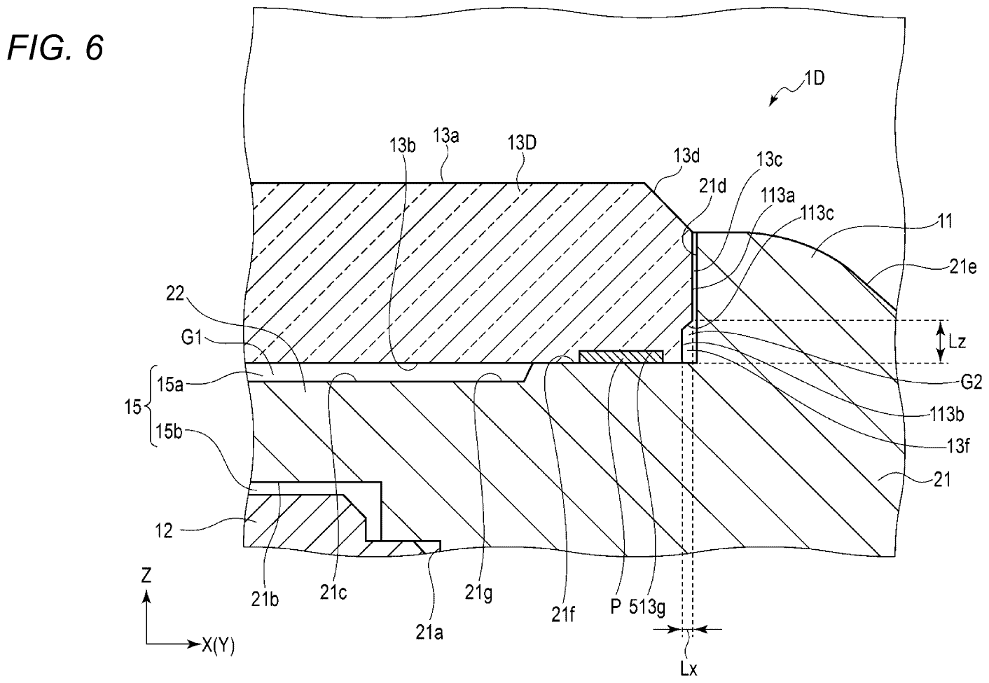

In the first illustrative embodiment, the second illustrative embodiment, another illustrative embodiment 1, and another illustrative embodiment 2, the example has been described in which the holding groove portion 21h in which adhesive P is arranged is formed in the bottom surface portion of the watch case 11 facing the back side of the cover 13. However, the present invention is not limited thereto. As in a cover 13D of a watch 1D shown in FIG. 6 as another illustrative embodiment 3, a holding groove portion 513g as a first recessed portion may be formed in the back surface 13b side of the cover 13D, which is a facing surface facing the bottom surface portion of the watch case 11. The holding groove portion 513g is a recessed portion where the back surface 13b of the cover 13D is retracted to the front side, and is configured to be able to hold the adhesive P. Note that in the watch 1D, the bottom support portion 21f of the watch case 11 is not formed with a groove and has a flat surface shape. In the present illustrative embodiment as well, the excess of the adhesive P supplied to the holding groove portion 513g is absorbed by the escape groove portion 13f, and thus the adhesive P can be suppressed from protruding from the gap between the watch case 11 and the cover 13D.

Additionally, different illustrative embodiments may be combined, and for example, the escape groove portions may be formed at multiple locations.

The watch 1 has been described as having a quadrangular shape, but may also have a circular shape. Note that when the watch 1 has a circular shape, the inner and outer direction is a radial direction. That is, the inner periphery side becomes a radial inner side, and the outer periphery side becomes a radial outer side.

Although several illustrative embodiments of the present invention have been described, the present invention is included in the invention described in the claims and their equivalents.

What is claimed is:

1. A device having an adhesive escape structure, the device comprising:
a case having an accommodation portion; and
a cover arranged in the accommodation portion of the case,
wherein a first recessed portion is formed in any one of a bottom surface portion in the accommodation portion of the case and a surface of the cover facing the bottom surface portion, and
wherein a second recessed portion is formed in an outer peripheral surface of the cover.

2. The device according to claim 1, wherein at least one of the first recessed portion or the second recessed portion holds an adhesive.

3. The device according to claim 1,
wherein the first recessed portion is formed in any one of a bottom surface portion of the accommodation portion of the case on a side facing the cover, or a surface of the cover facing the bottom surface portion of the case, and
wherein a gap is formed between the outer peripheral surface of the cover and a peripheral wall portion of the accommodation portion by the second recessed portion of the cover.

4. The device according to claim 1,
wherein the cover is made of a light-transmitting material, has a plate shape, and is configured to cover one side of the accommodation portion, and
wherein the second recessed portion of the cover comprises a longitudinal surface portion facing an inner surface of a peripheral wall portion of the accommodation portion of the case with a gap interposed therebetween and following a first direction that is a thickness direction of the cover, and a ceiling portion facing the bottom surface portion of the case.

5. The device according to claim 4, wherein the ceiling portion has an inclined surface inclined with respect to the longitudinal surface portion and the bottom surface portion of the case and extending from the longitudinal surface portion toward a front side and an outer periphery side of the case.

6. The device according to claim 4, wherein the longitudinal surface portion is located closer to an inner side of the case than a first peripheral surface portion of the outer peripheral surface of the cover.

7. The device according to claim 4, wherein the second recessed portion has a length in the first direction along a front and back direction of the case greater than a length in a peripheral direction of the case orthogonal to the first direction.

8. The device according to claim 4, wherein the second recessed portion is arranged at a distance from the first recessed portion on an outer periphery side of the case.

9. A watch comprising:
the device according to claim 1; and
a watch module provided in the case.

10. A method for manufacturing a device, the method comprising:
applying an adhesive to a first recessed portion formed in at least one of a bottom surface portion of an accommodation portion of a case or a lower surface of a cover; and
inserting and adhesively fixing the cover into the accommodation portion of the case after applying the adhesive,
wherein in the inserting and adhesively fixing the cover, the adhesive protruding from the first recessed portion enters a second recessed portion formed in an outer peripheral surface of the cover.
